(19) United States
(12) Patent Application Publication
(10) Pub. No.: US 2026/0057237 A1
(43) Pub. Date: Feb. 26, 2026

(54) METHOD AND SYSTEM FOR TRAINING A BLOCK TRANSFORMER ARCHITECTURE MODEL

(71) Applicant: LG MANAGEMENT DEVELOPMENT INSTITUTE CO., LTD., Seoul (KR)

(72) Inventors: Hyun Jik JO, Seoul (KR); Nam Gyu HEO, Seoul (KR); Yi Reun KIM, Seoul (KR)

(21) Appl. No.: 19/375,907

(22) Filed: Oct. 31, 2025

Related U.S. Application Data
(63) Continuation of application No. PCT/KR2025/007664, filed on Jun. 4, 2025.

(30) Foreign Application Priority Data
Jun. 27, 2024 (KR) 10-2024-0084854
Jun. 4, 2025 (KR) 10-2025-0073153

(51) Int. Cl. G06N 3/08; G06N 3/045

(52) U.S. Cl. CPC G06N 3/08; G06N 3/045

(57) ABSTRACT

Provided is a computer-implemented method for training a block transformer architecture model including: generating a plurality of input token embeddings by processing input data in a form of a sequence, generating a plurality of block embeddings by sequentially merging the plurality of input token embeddings into a predetermined unit number, generating a plurality of context embeddings by performing a self-attention operation on the plurality of block embeddings, wherein each of the plurality of context embeddings corresponds to each of the block embeddings, and generating a subsequent predicted token embedding for the plurality of input token embeddings, based on the plurality of context embeddings.

### CROSS REFERENCE TO RELATED APPLICATIONS

This application is a Bypass Continuation of International Patent Application No. PCT/KR2025/007664, filed on Jun. 4, 2025, which claims priority from and the benefit of Korean Patent Application No. 10-2024-0084854, filed on Jun. 27, 2024 and Korean Patent Application No. 10-2025-0073153, filed on Jun. 4, 2025, each of which is hereby incorporated by reference for all purposes as if fully set forth herein.

### BACKGROUND

### Field

Embodiments of the invention relate generally to a method and system for training a block transformer architecture model, and more particularly, to a method and system for training a block transformer architecture model, the method and system converting a sequence input into a plurality of input token embeddings, grouping and merging a plurality of input token embeddings into a plurality of block embeddings, wherein each of the plurality of block embeddings includes a merge of a predetermined number of input token embeddings, and calculating predicted data based on a result of performing a self-attention operation on the plurality of block embeddings, thereby reducing a computation load compared to a case in which a self-attention operation is performed on all of the plurality of input token embeddings.

### Discussion of the Background

Recently, with the development of Artificial Intelligence (AI) technology, various services using artificial intelligence have been commercialized in various industries. Such artificial intelligence technology may output information desired by a user in response to various types of inputs such as images, voices, and texts through an artificial neural network model that has learned a vast amount of data. This automates knowledge-intensive tasks such as prediction, classification, and generation, and rapidly improves productivity across the industry.

In this trend, an Large Language Model (LLM) with billions to hundreds of billions of training parameters emerges, and the ability to understand and generate natural language has improved dramatically. The LLM is applied to a wide range of fields such as question and answer, document summary, multilingual translation, and code autocomplete, and has established itself as a key platform in many industries such as search, education, healthcare, and fintech.

A transformer which constitutes the basis of the LLM is an attention mechanism based on query-key-value (QKV) and has a structure capable of training the relationship across the input sequence in a parallel manner. The transformer has been developed into an encoder-decoder structure, an encoder-only structure (BERT based), and a decoder-only structure (GPT based), and is widely spread in various domains such as video, voice, and time series data as well as natural language.

Among the above transformer structures, the decoder-only transformer sequentially generates subsequent tokens in an autoregressive manner while masking the past tokens. Thanks to these characteristics, it is being adopted as a mainstream model in applications sensitive to response delay, such as real-time interactive services or code auto-completion.

However, since the decoder-only transformer needs to load the key value (KV) cache of all previous tokens at each step to calculate the attention score, the amount of computation and the memory I/O increase in proportion to the square (O(L²)) of the token length L. Accordingly, the conventional decoder-only transformer has excellent expressiveness when modeling long text, but there is a structural limitation in that the computation and memory cost become excessively large as the sequence length increases.

Therefore, there is a need for research on an improved transformer architecture capable of significantly reducing computational load and memory consumption while maintaining the same prediction performance.

The above information disclosed in this Background section is only for understanding of the background of the inventive concepts, and, therefore, it may contain information that does not constitute prior art.

### SUMMARY

One embodiment of the present disclosure provides a computer-implemented method for training a block transformer architecture model comprising: generating a plurality of input token embeddings by processing input data in a form of a sequence, generating a plurality of block embeddings by sequentially merging the plurality of input token embeddings by a predetermined unit number, generating a plurality of context embeddings by performing a self-attention operation on the plurality of block embeddings, wherein each of the plurality of context embeddings corresponds to each of the block embeddings, and generating a subsequent predicted token embedding for the plurality of input token embeddings, based on the plurality of context embeddings.

The generating of the subsequent predicted token embedding may include: generating subsequent token embedding by sequentially generating a plurality of input token embeddings corresponding to a subsequent block embedding of a block embedding for a context embedding using information about the context embedding among the plurality of context embeddings as input, wherein the subsequent token embedding is generated by referring to previously generated token embeddings.

The method may further comprise: generating an additional subsequent block embedding corresponding to the sequence following a last sequence by merging the plurality of input token embeddings generated based on a context embedding corresponding to the last sequence among the plurality of context embeddings; and generating a plurality of context embeddings by performing a self-attention operation again on the plurality of block embeddings and the additional subsequent block embedding, each of the plurality of context embeddings corresponds to each of the block embeddings.

The generating of the subsequent token embedding may include sequentially generating a plurality of input token embeddings corresponding to a subsequent block embedding of a block embedding for the context embedding for all of the plurality of context embeddings.

In another aspect, each of the plurality of block embeddings may be generated by performing a concatenation of the predetermined unit number of input token embeddings arranged in order.

The predetermined unit number may be four.

The generating of the subsequent token embedding based on the context embedding may include: generating at least one context injection embedding based on the context embedding, and generating the subsequent token embedding in an autoregressive manner based on a self-attention operation on the at least one context injection embedding and the previous token embeddings generated sequentially.

The generating of the at least one context injection embedding may include generating the at least one context injection embedding via linear transformation of one context embedding.

The generating of the at least one context injection embedding may include generating a plurality of context injection embeddings via linear transformation of the context embedding.

Training parameters may be evenly allocated to a block decoder and a token decoder, in which the block decoder is configured to perform a self-attention operation on the plurality of block embeddings, and in which the token decoder is configured to perform a self-attention operation on the at least one context injection embeddings and the previous token embeddings generated sequentially.

The generating of the plurality of input token embeddings may include: generating a plurality of input tokens processing the input data in a form of the sequence; and generating the plurality of input token embeddings based on the plurality of input tokens.

Another embodiment of the present disclosure provides a system for training a block transformer architecture model comprising: at least one memory; and at least one processor configured to read-out at least one instruction stored in the at least one memory and configured to perform a transformer architecture-based inference method based on the at least one instruction, wherein the at least one processor is configured to: generate a plurality of input token embeddings by processing input data in a form of a sequence, generate a plurality of block embeddings by sequentially merging the plurality of input token embeddings by a predetermined unit number, generate a plurality of context embeddings by performing a self-attention operation on the plurality of block embeddings, wherein each of the plurality of context embeddings corresponds to each of the block embeddings, and generate a subsequent predicted token embedding for the plurality of input token embeddings, based on the plurality of context embeddings

In the generating of the subsequent predicted token embedding, the at least one processor is configured to generate subsequent token embedding by sequentially generating a plurality of input token embeddings corresponding to a subsequent block embedding of a block embedding for a context embedding using information about the context embedding among the plurality of context embeddings as input, wherein the subsequent token embedding is generated by referring to previously generated token embeddings.

The system may comprise: a plurality of neurons, each neuron including an array, wherein the array includes at least one register, at least one programmable logic, and at least one input interface; a plurality of synaptic circuits configured to store synaptic weights for adjusting connection strengths between the plurality of neurons; and at least one routing network configured to control data flow between the plurality of neurons, wherein each of the plurality of neurons further includes a field programmable gate array (FPGA) for a predetermined artificial neural network connected to at least another neuron via the routing network and configured to set a transfer path of the weight.

The system may comprise: a plurality of neurons, each neuron including an array, in which the array includes at least one register, at least one microprocessor, and at least one input; and a plurality of synaptic circuits configured to store synaptic weights for adjusting connection strengths between the plurality of neurons, in which each of the plurality of neurons further includes an application-specific integrated circuit (ASIC) for a predetermined artificial neural network connected to at least another neuron via one of the plurality of synaptic circuits.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a schematic example of a block diagram of a computing system implementing a block transformer architecture-based inference service according to an embodiment.

FIG. 2 is a schematic structure of a neuromorphic circuit that is included in a processor according to an embodiment.

FIG. 3 is a schematic example of a block diagram of a computing device implementing a block transformer architecture-based inference service according to an embodiment.

FIG. 4 is a schematic illustration of a block diagram in another aspect of a computing device implementing a block transformer architecture-based inference service according to an embodiment.

FIG. 5 is a schematic block diagram illustrating an example configuration of a block transformer architecture according to an embodiment.

FIG. 6 is a schematic diagram illustrating a configuration of various layers included in a block transformer architecture according to an embodiment.

FIG. 7 is a schematic diagram illustrating a method for generating at least one context injection embedding in context embedding according to an embodiment.

FIG. 8 is a schematic graph illustrating training performance of a language model according to a manner in which a plurality of context embeddings are applied to an attention operation in a token decoder in a block transformer architecture according to an embodiment.

FIG. 9 is a schematic graph identifying change in a perplexity of a language model based on a length of a block embedding and a distribution ratio of training parameters into between a block decoder and a token decoder.

FIG. 10 is a schematic flowchart of a method for training a block transformer architecture model according to an embodiment.

FIG. 11 is a schematic flowchart of a step of generating a subsequent token embedding based on any one context embedding included in the method for training the block transformer architecture model for FIG. 10.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

The system 1000 for providing a block transformer architecture-based inference service according to an embodiment may generate a plurality of token by processing input data in a form of a sequence, may generate a plurality of block embeddings by merging the plurality of tokens into a predetermined unit number (N), and, may perform a global attention operation on the plurality of block embeddings, and may apply a result obtained by performing the global attention operation to a plurality of input token groups corresponding to the plurality of block embeddings, and then may perform a local attention operation in each of the groups to generate a predicted token in an autoregressive manner.

For example, unlike the conventional general transformer architecture having O(L²) computational complexity on a total of L input tokens, the block transformer architecture of the system 1000 according to an embodiment may perform an attention operation of O(N²) complexity on each of the L/N groups to learn a global context of the input data at a lower computational complexity of a total O((L/N)·N²=L·N) level, and generate an appropriate predicted token on the input data based thereon.

In addition, the KV-cache size and the memory I/O required for the attention operation in each layer of the block transformer architecture of the system 1000 according to an embodiment may be reduced to the 1/N to 1/N² level, so that both the batch throughput and the delay time during inference are significantly improved. Due to such structural characteristics, the system 1000 according to an embodiment may rapidly generate predicted data while significantly improving computation efficiency and memory efficiency even in a long sequence.

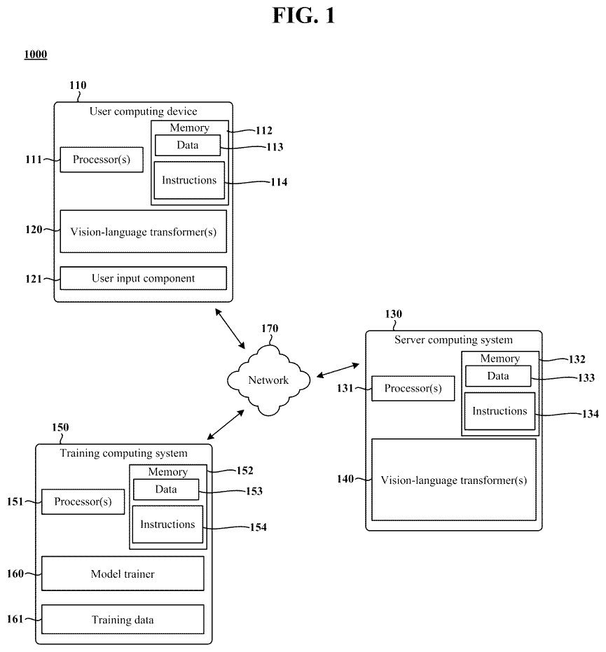

FIG. 1 illustrates a schematic example of a block diagram of a computing system 1000 implementing a block transformer architecture-based inference service according to an embodiment.

Referring to FIG. 1, the computing system 1000 implementing a block transformer architecture-based inference service according to an embodiment may include a user computing device 110, a server computing system 130, and a training computing system 150, which are capable of communicating with each other through a wireless or wired network 170.

A block transformer architecture-based interference method according to an embodiment may be implemented and provided locally by the user computing device 110, may be implemented and provided in a form of a web service by the server computing system 130 communicating with the user computing device 110, and may be implemented and provided in association with the user computing device 110 and the server computing system 130.

For example, in an embodiment, the user computing device 110 and/or the server computing system 130 may train a machine learning model 120 and/or 140 (or vision-language transformer) via interaction with the training computing system 150 communicatively connected thereto via the network 170. The training computing system 150 may be separated from the server computing system 130 or may be a part of the server computing system 130.

For example, an AI model may be trained by 1) the user computing device 110 directly locally, 2) the server computing system 130 and the user computing device 110 interacting with each other via the network 170, and 3) the separate training computing system 150 using various training techniques and training techniques. The artificial intelligence model trained by the training computing system 150 may be transmitted to the user computing device 110 and/or the server computing system 130 via the network 170 and may be provided/updated thereby.

In some embodiments, the training computing system 150 may be a part of the server computing system 130, or may be a part of the user computing device 110.

The user computing device 110 may include any type of a computing device, such as a smart phone, a mobile phone, a digital broadcasting device, personal digital assistants (PDA), a portable multimedia player (PMP), a desktop, a wearable device, an embedded computing device, and/or a tablet PC.

In addition, in an embodiment, the user computing device 110 may further include a predetermined server computing device that provides a block transformer architecture-based inference service environment.

This user computing device 110 may include at least one processor 111 and a memory 112.

For example, the processor 111 of the user computing device 110 may include at least one of a central processing unit (CPU), a graphic processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other types of electrical units for performing functions, or a plurality of electrically connected processors.

In particular, according to an embodiment, the processor 111 may be configured based on a Field Programmable Gate Array (FPGA) and/or an Application Specific Integrated Circuit (ASIC) as a hardware scheme for implementing a predetermined digital circuit.

For example, the field programmable gate array (FPGA) may mean a flexible digital circuit that is programmable based on user needs.

In an embodiment, the field programmable gate array may include a register that temporarily stores data therein and controls a flow and timing of a signal to maintain an operation intermediate result or state information to support a synchronized operation of the FPGA, a programmable logic that programs an internal operation of the FPGA to perform a specific function or operation as configurable logic circuits based on user needs, and an input interface that acts as a channel for receiving data from an external surface to the FPGA and receives a signal from an external device or a sensor and transmits the signal to the internal circuit.

Via the combination of the above components, the field programmable gate array may provide flexible and various types of digital circuits.

In an example, the application-specific integrated circuit (ASIC) may refer to a customized integrated circuit fixedly designed to perform a specific purpose or function.

According to an embodiment, the application-specific integrated circuit may include a register that is a small memory device that temporarily stores therein and manages data and supports a fast operation of the ASIC by storing a calculation intermediate result or state information, a microprocessor acting as a central processing unit for performing control and operation in the ASIC and performing various operations and generating a control signal if necessary to control all operations of the system, and an input block that acts as an interface for receiving data from an external source and receives data to be processed by the ASIC and transmits the received data to the inside thereof, and receives various input data via a connection with a sensor or an external device.

Via the combination of the above components, the application-specific integrated circuit may perform a task of a specific purpose in an optimized manner.

For example, the ASIC may have a structure of an array-type neuromorphic circuit including a plurality of neuron circuits.

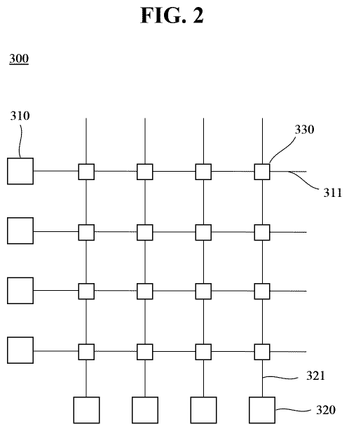

FIG. 2 is a schematic diagram illustrating a structure of a neuromorphic circuit that may be included in the processor 111 according to an embodiment.

Referring to FIG. 2, for example, a neuromorphic circuit 300 may include a plurality of pre-synaptic neuron circuits 310, a plurality of pre-synaptic lines 311 extending in a row direction (or horizontal direction) from the plurality of pre-synaptic neuron circuits 310, a plurality of post-synaptic neuron circuits 320, a plurality of post-synaptic lines 321 extending in a column direction (or vertical direction) from the plurality of post-synaptic neuron circuits 320, and a plurality of synaptic circuits 330 respectively provided at intersections between the plurality of pre-synaptic lines 311 and the plurality of post-synaptic lines 321.

The plurality of pre-synaptic neuron circuits 310 may transmit a signal input from an external source to the plurality of synaptic circuits 330 via the plurality of pre-synaptic lines 311 in the form of an electrical signal.

In addition, the plurality of post-synaptic neuron circuits 320 may receive electrical signals from the plurality of synaptic circuits 330 via the plurality of post-synaptic lines 321.

Furthermore, the plurality of post-synaptic neuron circuits 320 may transmit electrical signals to the plurality of synaptic circuits 330 via the plurality of post-synaptic lines 321.

The plurality of synaptic circuits 330 may store therein weights included in layers constituting the neural network system implemented by the neuromorphic circuit 300, and may perform a predetermined operation based on the weights and the input data.

For example, each of the plurality of synapse circuits 330 may include a resistive memory cell having a variable resistance. For example, the plurality of synaptic circuits 330 may have a resistance value varying based on a voltage applied via the plurality of pre-synaptic neuron circuits 310 or the plurality of post-synaptic neuron circuits 320, and may store therein weight data based on such a change in the resistance.

The neuromorphic circuit 300 may be formed by simulating neurons and synaptic structures that are essential elements of the human brain. When a Deep neural network (DNN) is realized using the neuromorphic circuit 300, data processing speed may be improved and power consumption may be reduced, compared to the case of using the conventional von Neumann structure.

Referring back to FIG. 1, the memory 112 of the user computing device 110 may also include one or more non-transitory/transitory computer readable storage media such as RAM, ROM, EEPROM, EPROM, flash memory devices, magnetic disks, etc., and combinations thereof, and may include web storage of a server that performs the storage function of the memory on the Internet. The memory 112 may store therein data 113 and instructions 114 necessary for the at least one processor 111 to perform functions or operations such as training an artificial intelligence model, generating a plurality of input token embeddings by processing the sequence input using the artificial intelligence model, or grouping and merging the plurality of input token embeddings into the plurality of block embeddings, each including the predetermined number N of input token embeddings, and performing the global attention operation on the plurality of block embeddings and/or performing the local attention operation in each of the plurality of input token embedding groups corresponding to the plurality of block embeddings.

In an embodiment, the user computing device 110 may perform various deep learning for the block transformer architecture-based inference service in conjunction with a deep-learning neural network.

For example, the deep learning neural network according to an embodiment may include a CNN (Convolution Neural Network), a Regions with CNN features (R-CNN), a Fast R-CNN, a Faster R-CNN, a Mask R-CNN, etc. and may include any deep learning neural network including an algorithm capable of performing an embodiment as described below, and an embodiment of the present disclosure does not restrict or limit the deep learning neural network itself.

For example, according to an embodiment, the deep learning neural network may be directly installed in the server computing system 130 or may operate as a separate device from the server computing system 130 to perform deep learning for the block transformer architecture-based inference service.

In addition, in an embodiment, the user computing device 110 may store therein at least one or more machine learning models 120 (or vision-language transformer).

For example, the user computing device 110 may be configured to include various machine learning models, such as a plurality of neural networks (e.g., Deep neural network) or other types of machine learning models including non-linear models and/or linear models, which may perform the block transformer architecture-based interference method based on structured/quantitative data, or a combination thereof.

For example, the machine learning model may store therein a linear regression, a decision tree, a random forest, a gradient boosting pre-trained language model, and/or a deep learning model. The neural network may include at least one of feed-forward neural networks, a recurrent neural network (e.g., long and short-term memory recurrent neural networks), a convolutional neural network, and/or other types of neural networks.

In addition, according to an embodiment, in order to perform at least some of the processes as performed for the block transformer architecture-based interference method using a large language model (LLM), the user computing device 110 may store therein a model to be used in each of the processes and a prompt template that is a basis of an input in the model.

In an embodiment, the user computing device 110 may receive at least one machine learning model 120 (or vision-language transformer) from the server computing system 130 via the network 170, store the at least one machine learning model in a memory 112, and then execute the stored machine learning model 120 (or vision-language transformer) using the processor 111 to process the sequence input to generate the plurality of input token embeddings or to group and merge the plurality of input token embeddings into the plurality of block embeddings, each having the predetermined unit number N of the input token embeddings, and to perform a global attention operation on the plurality of block embeddings, and/or perform a local attention operation in each of the plurality of input token embedding groups corresponding to the plurality of block embeddings.

In another embodiment, the user computing device 110 may cooperate with the server computing system 130 to perform an operation using the machine learning model 140 (or vision-language transformer) including at least one machine learning model, and may provide the block transformer architecture-based inference service to the user in a manner of communicating data related thereto with an external device.

For example, the user computing device 110 may perform the block transformer architecture-based inference service in such a way that the server computing system 130 provides an output in response to a user's input using the machine learning model 140 (or vision-language transformer) via the web.

In addition, an artificial intelligence model may be implemented in such a way that at least some of the machine learning models 120 and/or 140 (or vision-language transformer) are executed in the user computing device 110 and the rest thereof are executed in the server computing system 130.

In addition, the user computing device 110 may include at least one user input component 121 (or input component) that senses a user's input.

For example, the user input component 121 may include a touch sensor (e.g., a touch screen and/or a touch pad) that senses a touch of an input medium (e.g., a finger or a stylus) of the user, an image sensor that senses a motion input of the user, a microphone that senses a user voice input, a button, a mouse, and/or a keyboard, and the like.

For example, the image sensor may include an image processing module. In detail, the image sensor may process a still image or a moving image obtained by an image sensor device (e.g., CMOS or CCD).

In addition, the image sensor may process the still image or the moving image obtained using the image sensor device using an image recognition process (e.g., OCR, etc.) and/or an image processing module to extract necessary information and transmit the extracted information to the processor.

In addition, the user input component 121 may receive an input to an external controller (e.g., a mouse, a keyboard, etc.) based on the interface module. However, it is not limited thereto, and any input device may be used therein. Furthermore, the user input component 121 may include an external output device (e.g., a speaker).

For example, the interface module may be configured to include at least one of a wired/wireless headset port, an external charger port, a wired/wireless data port, a memory card port, a port for connecting a device provided with an identification module, an audio input/output (I/O) port, a video input/output (I/O) port, an earphone port, a power amplifier, an RF circuit, a transceiver, and other communication circuits.

The external output device may also include a display system that outputs various information related to the block transformer architecture-based inference service as a graphic image.

The display system may include at least one of a liquid crystal display (LCD), a thin film transistor-liquid crystal display (TFT LCD), an organic light-emitting diode (OLED D display), a flexible display, a 3D display, and an e-ink display.

In an example, the user computing device 110 including the above-described components may further perform at least some of function operations performed by the server computing system 130 to be described later.

The server computing system 130 may perform a series of processes configured to provide the block transformer architecture-based inference service.

Particularly, in an embodiment, the server computing system 130 may provide the block transformer architecture-based inference service by exchanging data necessary to cause a block transformer architecture-based inference service process to be executed on an external device, such as the user computing device 110, with the external device.

More particularly, in an embodiment, the server computing system 130 may provide an environment in which an application may operate on the user computing device 110.

To this end, the server computing system 130 may include an application program, data, and/or instructions for operating the application, and may transmit and receive various data based thereon to and from the external device.

In addition, the server computing system 130 may include at least one processor 131 and a memory 132.

For example, the processor 131 of the server computing system 130 may be configured to include at least one of a central processing unit (CPU), a graphic processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions, or a plurality of electrically connected processors.

In particular, according to an embodiment, the processor 131 may be configured based on a Field Programmable Gate Array (FPGA) and/or an Application Specific Integrated Circuit (ASIC) as a hardware scheme for implementing a predetermined digital circuit. A detailed description thereof may be subject to the description of FPGA and ASIC described above and thus will be omitted.

Furthermore, the memory 132 may include one or more non-transitory/transitory computer readable storage media such as RAM, ROM, EEPROM, EPROM, flash memory devices, magnetic disks, and the like, and combinations thereof. The memory 132 may store data 133 and instructions 134 necessary for the processor 131 to perform a function operation, such as training an artificial intelligence model, processing a sequence input via the artificial intelligence model to generate the plurality of input token embeddings, or grouping and merging the plurality of input token embeddings into the plurality of block embeddings, each having a predetermined unit number N of input token embeddings and executing the global attention operation on the plurality of block embeddings, and/or executing the local attention operation in each of a plurality of input token embedding groups corresponding to the plurality of block embeddings.

In an embodiment, the server computing system 130 may be configured to include at least one computing device. For example, the server computing system 130 may be implemented to operate the plurality of computing devices based on a sequential computing architecture, a parallel computing architecture, or a combination thereof. In addition, the server computing system 130 may include a plurality of computing devices connected to the network 170.

The server computing system 130 may also store therein at least one machine learning model 140 (or vision-language transformer). For example, the server computing system 130 may include a neural network and/or other multi-layer non-linear models as the machine learning model 140 (or vision-language transformer). An example neural network may include a feed forward neural network, a deep neural network, a recurrent neural network, and a convolutional neural network.

In an embodiment, the server computing system 130 may further include a data store computing system (hereinafter, referred to as a data store) as storage for continuously storing therein and managing raw data as the basis of the block transformer architecture-based inference service.

This data store may include various types of data storage, ranging from a file system to cloud storage. For example, the data store may include at least one of a relational database using a structured query language in SQL) to define and manipulate data, a NoSQL database designed for flexibility and scalability to process unstructured and semi-structured data, a data warehouse optimized for query and analysis by centralizing large amounts of data from multiple sources, a data warehouse storing therein structured data, semi-structured data, and unstructured data as basic types of large amounts of raw data, or a local storage device or a network attached storage (NAS) that stores data in a file in a format generally accessible by a computer operating system, as a system used for reporting and data analysis.

The training computing system 150 may include at least one processor 151 and a memory 152. For example, the processor 151 of the training computing system 150 may include at least one of a central processing unit (CPU), a graphic processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions, or a plurality of electrically connected processors.

In particular, according to an embodiment, the processor 151 may be configured based on a Field Programmable Gate Array (FPGA) and/or an Application Specific Integrated Circuit (ASIC) as a hardware scheme for implementing a predetermined digital circuit. A detailed description thereof may be subject to the description of FPGA and ASIC as described above and thus will be omitted below.

Moreover, the memory 152 may include one or more non-transitory/transitory computer readable storage media such as RAM, ROM, EEPROM, EPROM, flash memory devices, magnetic disks, and the like, and combinations thereof. The memory 152 may store therein data 153 and instructions 154 necessary for the processor 151 to perform training of an artificial intelligence model.

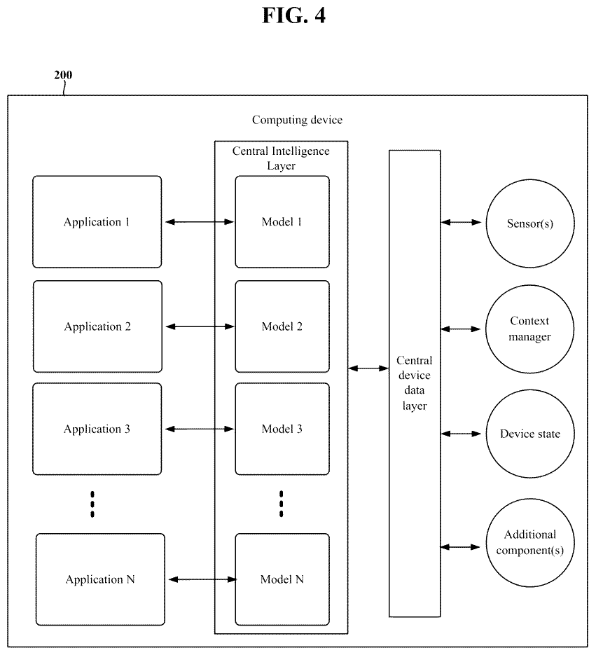

For example, the training computing system 150 may include a model trainer 160 that trains the machine learning models 120 and/or 140 (or vision-language transformer) stored in the user computing device 110 and/or the server computing system 130 using various training or learning techniques such as backpropagation of errors (based on a framework shown in FIG. 4).

In an example, the model trainer 160 may perform updates of one or more parameters of the machine learning models 120 and/or 140 (or vision-language transformer) for the block transformer architecture-based inference service in a backpropagation manner based on a defined loss function.

In some embodiments, performing the backpropagation of the error may include performing truncated backpropagation through time. The model trainer 160 may perform a number of generalization techniques (e.g., weight reduction, drop out, knowledge distillation, etc.) to improve the generalization capability of the trained machine learning model 120 and/or 140 (or vision-language transformer).

Further, the model trainer 160 may train the machine learning model 120 and/or 140 (or vision-language transformer) based on the series of training data 161. For example, the training data 161 may include different formats of data, such as, for example, images, audio samples, and/or text, etc. Examples of image types that may be used may include video frames, LiDAR point clouds, X-ray images, computed tomography scans, hyperspectral images, and/or various other forms of images.

Such training data 161 may be provided from the user computing device 110 and/or the server computing system 130. When the training computing device trains the machine learning model 120 and/or 140 (or vision-language transformer) based on specific data of the user computing device 110, the machine learning model 120 and/or 140 (or vision-language transformer) may be characterized as a personalized model.

Moreover, the model trainer 160 may include a computer logic utilized to provide desired functionality.

In addition, the model trainer 160 may be implemented using hardware, firmware, and/or software that controls a general-purpose processor. In one embodiment, the model trainer 160 may include a program file stored in a storage device, and may be loaded into the memory 152 and executed by one or more processors 151. In another embodiment, the model trainer 160 may include one or more sets of computer-executable data 153 and instructions 154 stored on a tangible computer-readable storage medium, such as a RAM hard disk or optical or magnetic medium.

The network 170 may include, but is not limited to, a 3rd Generation Partnership Project (3GPP) network, a long term evolution (LTE) network, a world interoperability for microwave access (WIMAX) network, the Internet, a local area network (LAN), a wireless local area network (Wireless LAN), a wide area network (WAN), a personal area network (PAN), a Bluetooth network, a satellite broadcasting network, an analog broadcasting network, and/or a digital multimedia broadcasting (DMB) network.

In general, communication over the network 170 may be performed using any type of wired and/or wireless connection, and via various communication protocols (e.g., TCP/IP, HTTP, SMTP, and/or FTP, etc.), encoding or formats (e.g., HTML and/or XML, etc.), and/or a protection schema (e.g., VPN, secure HTTP, and/or SSL, etc.).

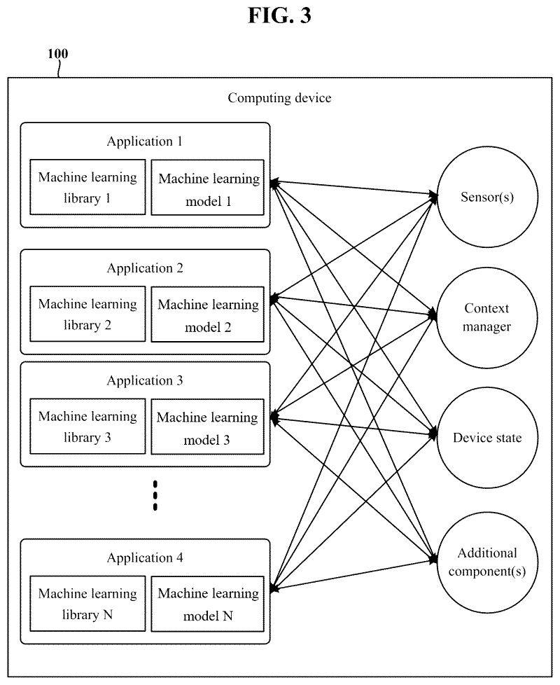

FIG. 3 is a schematic example of a block diagram of a computing device 100 implementing a block transformer architecture-based inference service according to an embodiment.

Referring to FIG. 3, the computing device 100 included in each of the user computing device 110, the server computing system 130, and the training computing system 150 may include multiple applications (e.g., applications 1 to N). Each application may include a machine learning library and one or more machine learning models. For example, the application may include an image processing (e.g., Detection, Classification, and/or Segmentation, etc.) application, a text messaging application, an email application, a dictation application, a virtual keyboard application, a browser application, and/or a Chat-bot application, etc.

In an embodiment, the computing device 100 may include the model trainer 160 for training an artificial intelligence model, and may store and operate the trained artificial intelligence model to provide output data based on predetermined input data.

Each of the applications of the computing device 100 may communicate with a number of other components of the computing device 100, such as, for example, at least one or more sensors, context managers, device status components, and/or additional components. In one embodiment, each application may communicate with each device component using an API (e.g., a public API). In one embodiment, the API used by each application may be specific to that application.

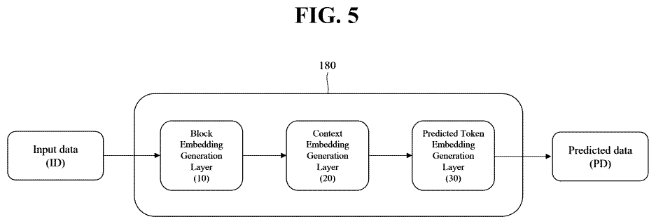

FIG. 4 is a schematic illustration of a block diagram in another aspect of a computing device 200 implementing a block transformer architecture-based inference service according to an embodiment. FIG. 5 is a schematic block diagram illustrating an example configuration of a block transformer architecture 180 according to an embodiment.

Referring to FIG. 4, the computing device 200 may include multiple applications (e.g., applications 1 to N). Each application may communicate with a central intelligence layer. For example, the applications may include an image processing application, a text message application, an email application, a dictation application, a virtual keyboard application, and/or a browser application, etc. In an embodiment, each application may communicate with the central intelligence layer (and a model stored therein) using an API (e.g., a common API across all applications).

The central intelligence layer may include multiple machine learning models. For example, as shown in FIG. 4, at least a portion of each machine learning model may be provided for each application and managed by the central intelligence layer. In another embodiment, two or more applications may share a single machine learning model. For example, in some embodiments, the central intelligence layer may provide a single model for all applications. In some embodiments, the central intelligence layer may be included in the operating system of the computing device 200 or may be otherwise implemented.

The central intelligence layer may communicate with a central device data layer. The central device data layer may be a centralized data store for the computing device 200. As shown in FIG. 5, the central device data layer may communicate with multiple other components of the computing device 200, such as, for example, one or more sensors, context managers, device status components, and/or additional components. In some embodiments, the central device data layer may communicate with each device component using an API (e.g., a private API).

The technology described herein may refer to servers, databases, software applications, and other computer-based systems as well as taken actions and information transmitted to or from the system. It will be appreciated that the inherent flexibility of computer-based systems allows for a wide range of possible configurations, combinations and division of work and functionality between and from components. For example, the processes described herein may be implemented using multiple devices or components that operate in a single device or component or combination. Databases and applications may be implemented in a single system or a distributed system across multiple systems. The distributed components may operate sequentially or in parallel.

Referring to FIG. 5, the block transformer architecture 180 used to perform a method for performing block transformer architecture model-based interference according to various embodiments of the disclosure may include a block embedding generation layer 10, a context embedding generation layer 20, and a predicted token embedding generation layer 30.

When input data ID is input to the block transformer architecture 180 from an external source, the block embedding generation layer 10 may process the input data ID to generate a plurality of block embeddings.

The input data ID in the form of a sequence may be received by the processor 111, 131, and 151. For example, the user may provide the input data in the form of a natural language command, a question, a file, sensor data, or the like via the user computing device 110.

For example, the input data ID may be of various types such as a video frame, sensor time series data, radar/lidar signals, code snippets, protein molecular structures, and behavioral logs in addition to text, voice, and image patches. The data may be converted into the sequence form and used as the input for subsequent processing.

The input data ID may be tokenized by the processor 111, 131, and 151 of the user computing device 110, the server computing system 130, and the training computing system 150, respectively. For example, text data may be divided into words or sub-words, and voice data may be divided into MFCCs, Mel spectrograms, or time-frequency patches based on Fourier transform coefficient. An image or video input may be divided into patches of a fixed size which are used as tokens.

A plurality of input tokens generated as a result of tokenization of the input data ID may be converted into a plurality of input token embeddings by the processor 111, 131, and 151 of the user computing device 110, the server computing system 130, and the training computing system 150, respectively. For example, each of the tokens may be mapped to a vector space of a predetermined dimension, and a corresponding embedding thereto may be generated by a pre-trained embedding table or a convolution-based or linear projection-based embedding layer.

The block embedding generation layer 10 may sequentially group and merge the plurality of input token embeddings into the plurality of block embeddings, and each block embedding may be composed of a predetermined unit number N of input token embeddings. This grouping and merging process may be a preprocessing step of dividing the entire sequence into the blocks, and each of the blocks may include a predetermined size, thereby increasing the efficiency of a subsequent attention operation.

For example, the predetermined number N of consecutive token embeddings may be merged with each other via a simple concatenation or mean pooling into one block embedding. The block embedding generated in this way may be used as an input for a block-by-block global attention operation.

The context embedding generation layer 20 may perform a global attention operation on the plurality of block embeddings to generate a plurality of context embeddings including global context information having a correlation between the plurality of block embeddings.

The context embedding generation layer 20 may receive the plurality of block embeddings as the input thereto and may use a block decoder structure in the form of a transformer decoder to model a relationship therebetween. The block decoder may perform a masked self-attention operation between the plurality of block embeddings to learn what semantic association each block has with blocks previous thereto and may output context embeddings corresponding to each block from the result of the operation.

For example, autoregressive flow in the computation process may be guaranteed by applying the masked self-attention. This may be important for maintaining causality in subsequent token prediction. Each context embedding may serve as a summary vector of global context information extracted from the corresponding block embedding and the previous block embeddings thereto and may then serve as a basis for a local attention-based token prediction operation.

The context embedding generation layer 20 may be implemented in a form in which a plurality of transformer decoder layers are stacked, wherein each of the layers uses a block embedding to generate a query Q, a key K, and a value V, and transmits global information via mutual attention weights between the blocks.

As described above, the context embedding generation layer 20 may be a key component that minimizes context disconnection between the blocks, maintains global semantic coherence, and enables balance between computation efficiency and expressiveness on the long sequence input, under a structure in which an entire sequence of the input data is divided into the blocks which may be individually processed.

The predicted token embedding generation layer 30 may receive one of the plurality of context embeddings as an input thereto configured to apply the received one to an input token group corresponding to a subsequent block embedding of the block embedding related to the corresponding context embedding, and then configured to perform a local attention operation in the corresponding token group, thereby configured to generate the predicted token embedding in an autoregressive manner.

In addition, predicted data PD corresponding to the input data in the form of a sequence may be provided based on the predicted token embedding generated by the predicted token embedding generation layer 30.

As described above, the global attention operation may be performed in the context embedding generation layer 20 such that the global context information related to the sequence input may be obtained. The local attention operation may be repeatedly performed on each of the plurality of input token groups in the predicted token embedding generation layer 30, such that the predicted token embedding is generated.

Accordingly, the block transformer architecture 180 according to an embodiment may reduce the computation complexity and memory I/O and thus may maintain high inference performance even with a significantly lower amount of computation and memory requirement than the conventional transformer architecture even in the process of processing a long sequence input.

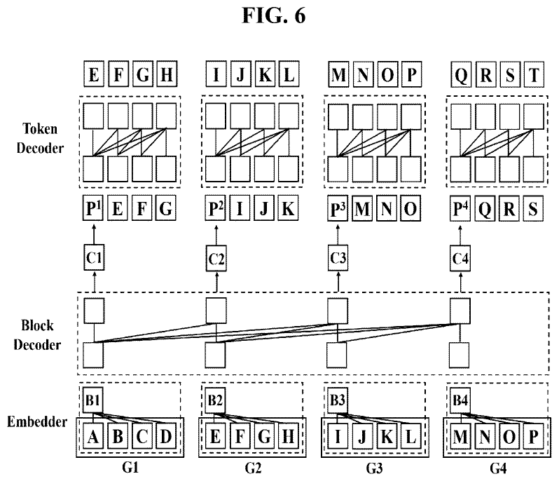

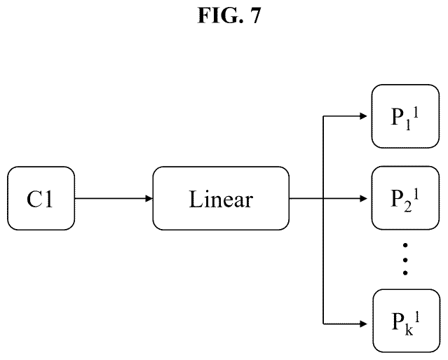

Hereinafter, configurations and functions of various layers included in the block transformer architecture 180 according to an embodiment will be described with reference to FIGS. 6 and 7.

FIG. 6 is a schematic diagram illustrating a configuration of various layers included in the block transformer architecture 180 according to an embodiment. FIG. 7 is a schematic diagram illustrating a method for generating at least one context injection embedding according to an embodiment.

The block transformer architecture 180 illustrated in FIG. 6 may further include basic components similar to those of the decoder-only transformer which is structurally common. For example, a positional embedding reflecting the position information may be added to each embedding, and each operation block may include a multi-head attention structure composed of a plurality of heads, an Add & Norm structure for performing residual connection and normalization, and a FFN (Feed-Forward Network) structure including a non-linear activation function. This detailed configuration is omitted in the drawings, but may be equally applied to the block transformer architecture 180 as in the conventional transformer architecture.

The block transformer architecture 180 according to various embodiments of the disclosure may include a structure that hierarchically performs a block-by-block global attention on a plurality of input token embeddings and a local attention inside the block in order to efficiently generate the predicted token in an autoregressive manner. To this end, the block transformer architecture 180 may include the following three components.

Referring to FIG. 6, the block transformer architecture 180 may include an embedder configured to group and merge a plurality of input token embeddings A, B, C, D, E, F, G, H, I, J, K, L, M, N, O, and P into a plurality of block embeddings B1, B2, B3, and B4, each block embedding including a merge of a predetermined unit number of input token embeddings, a block decoder configured to generate a plurality of context embeddings C1, C2, C3, and C4 by performing a global attention operation on the plurality of block embeddings B1, B2, B3, and B4, and a token decoder configured to apply the plurality of context embeddings C1, C2, C3, and C4 to the plurality of input token embedding groups G1, G2, G3, and G4 corresponding to the plurality of block embeddings B1, B2, B3, and B4 and then performing a local attention operation within each of the groups, thereby outputting the predicted token embedding.

For example, the embedder may correspond to the block embedding generation layer 10 of the block transformer architecture 180, the block decoder may correspond to the context embedding generation layer 20 of the block transformer architecture 180, and the token decoder may correspond to the predicted token embedding generation layer 30 of the block transformer architecture 180.

The block transformer architecture 180 may be pre-trained so as to receive the plurality of input token embeddings A, B, C, D, E, F, G, H, I, J, K, L, M, N, O, and P generated by tokenizing and vectorizing the input data in the form of the sequence, and may generate a plurality of predicted token embeddings E, F, G, H, I, J, K, L, M, N, O, P, Q, R, S, and T in an autoregressive manner.

Hereinafter, a process in which the pre-trained block transformer architecture 180 performs learning so as to generate the predicted data in an autoregressive manner via a predetermined operation based on input data will be described.

In order to train the block transformer architecture 180, the plurality of input token embeddings A to P corresponding to predetermined sequence data may be given as an input thereto, and a plurality of ground truth token embeddings E, F, G, H, I, J, K, L, M, N, O, P, Q, R, S, and T at a position subsequent to the input by one block may be given as the ground truth.

For example, the fact that the plurality of ground truth token embeddings E, F, G, H, I, J, K, L, M, N, O, P, Q, R, S, and T are located subsequent to the plurality of input token embeddings A, B, C, D, E, F, G, H, I, J, K, L, M, N, O, and P by one block means that the plurality of ground truth token embeddings E, F, G, H, I, J, K, L, M, N, O, P, Q, R, S, and T are composed of token embeddings that are subsequent to, by a predetermined unit number N of token embeddings merged with each other to generate one block embeddings to be described later, the plurality of input token embeddings A, B, C, D, E, F, G, H, I, J, K, L, M, N, O, and P. The plurality of ground truth token embeddings E, F, G, H, I, J, K, L, M, N, O, P, Q, R, S, and T may be used as an output target of the block transformer architecture 180 based on a block-by-block autoregressive learning structure.

The embedder may sequentially group and merge the plurality of input token embeddings A, B, C, D, E, F, G, H, I, J, K, L, M, N, O, and Pinto a plurality of block embeddings B1, B2, B3, and B4, each having a merge of the predetermined unit number N of token embeddings. For example, the embedder may generate a first block embedding B1 by merging a plurality of input token embeddings A, B, C, and D included in the first input token group G1 with each other, may generate a second block embedding B2 by merging a plurality of input token embeddings E, F, G, and H included in the second input token group G2 with each other, may generate a third block embedding B3 by merging a plurality of input token embeddings I, J, K, and L included in the third input token group G3 with each other, and may generate a fourth block embedding B4 by merging a plurality of input token embeddings M, N, O, and P included in the fourth input token group G4 with each other.

For example, for example, the plurality of input token embeddings PA, B, C, D, E, F, G, H, I, J, K, and L belonging to the first to third input token groups G1, G2, and G3 may be prompt data input by the user, and the plurality of tokens M, N, O, P, Q, R, S, and T subsequent to the third input token group G3 among the plurality of ground truth token embeddings E, F, G, H, I, J, K, L, M, N, O, P, Q, R, S, and T given as the ground truth data may be data predicted on the prompt data.

For example, the embedder may integrate the predetermined unit number N of consecutive input token embeddings among the plurality of input token embeddings A, B, C, D, E, F, G, H, I, J, K, L, M, N, O, and P with each other in a simple concatenation or mean pooling scheme, thereby generating one block embedding. The block embedding generated in this way may be used as an input for a block-by-block global attention operation.

The block decoder may perform a self-attention operation on the plurality of block embeddings B1, B2, B3, and B4 generated by the embedder to generate each of a plurality of context embeddings C1, C2, C3, and C4 corresponding to each of the block embeddings.

For example, the block decoder may effectively grasp the global semantic relationship between the plurality of input token groups G1, G2, G3, and G4 by modeling the entire input sequence on a block basis, and each context embedding may include global context information in a compressed format as required to predict a token of a subsequent group.

In addition, the plurality of context embeddings C1, C2, C3, and C4 generated as described above may be input to the token decoder and may serve to provide the global context information when performing the local attention operations on the plurality of input token embedding groups G1, G2, G3, and G4, thereby enabling precise language generation while maintaining efficient inference performance.

The token decoder may be trained to apply information on the plurality of context embeddings C1, C2, C3, and C4 to the plurality of input token embedding groups G1, G2, G3, and G4 corresponding to the plurality of block embeddings B1, B2, B3, and B4 and then perform a local attention operation in each of the groups, thereby outputting the plurality of ground truth token embeddings E, F, G, H, I, J, K, L, M, N, O, P, Q, R, S, and T. For example, the local attention operation may include a masked self-attention operation on input embeddings.

For example, the token decoder may receive information on one context embeddings among the plurality of context embeddings C1, C2, C3, and C4 as the input thereto, and sequentially generate a plurality of input token embeddings corresponding to a block embedding subsequent to a block embedding corresponding to the one context embedding. For example, the token decoder generates a subsequent token embedding with reference to a generated previous token embedding.

For example, the token decoder may receive information about the first context embeddings C1 as the input thereto and sequentially generate a plurality of input token embeddings E, F, G, and H corresponding to the second block embedding B2 as a subsequent block embedding to the first block embedding B1 corresponding to the first context embeddings C1.

For example, when sequentially generating the plurality of input token embeddings E, F, G, and H, the token decoder may generate the subsequent token embedding with reference to the generated previous token embedding.

For example, the token decoder may be trained to first generate an E token embedding based on information about the first context embedding C1, then generate an F token embedding based on the information about the first context embedding C1 and the E token embedding, then generate an G token embedding based on the information about the first context embedding C1, the E token embedding, and the F token embedding, and finally generate an H token embedding based on the information about the first context embedding C1, the E token embedding, the F token embedding, and the G token embedding.

In this manner, the token decoder may sequentially generate the I token embedding to L token embedding with referring to the second context embedding C2 as a global context, wherein the token decoder may be trained in an autoregressive manner using token embeddings (at least one of I, J, and K) generated previously to each time point together with the second context embedding C2 as the inputs.

Further, the token decoder may sequentially generate the M token embedding to P token embedding with referring to the third context embedding C3 as a global context, wherein the token decoder may be trained in an autoregressive manner using token embeddings (at least one of M, N, and O) generated previously to each time point together with the third context embedding C3 as the inputs.

Further, the token decoder may sequentially generate the Q token embedding to T token embedding with referring to the fourth context embedding C4 as a global context, wherein the token decoder may be trained in an autoregressive manner using token embeddings (at least one of Q, R, and S) generated previously to each time point together with the fourth context embedding C4 as the inputs.

In an example, when applying information on the plurality of context embeddings C1, C2, C3, and C4 to the plurality of input token embedding groups G1, G2, G3, and G4 corresponding to the plurality of block embeddings B1, B2, B3, and B4, the token decoder may use a plurality of context injection embeddings P¹, P², P³, and P⁴ generated via linear transformation on the plurality of context embeddings C1, C2, C3, and C4 as inputs for the local attention operation in each of the groups.

For example, referring to FIG. 7, the first context embedding C1 may be linearly transformed by a predetermined linear layer to generate a plurality of first context injection embeddings P₁¹, P₂¹, . . . Pₖ¹.

For example, the token decoder may generate the E token embedding based on the plurality of first context injection embeddings P₁¹, P₂¹, . . . Pₖ¹, generate the F token embedding based on the first context injection embeddings P₁¹, P₂¹, . . . Pₖ¹ and the E token embedding, generate the G token embedding based on the first context injection embeddings P₁¹, P₂¹, . . . Pₖ¹, the E token embedding, and the F token embedding, and generate the H token embedding based on the first context injection embeddings P₁¹, P₂¹, . . . Pₖ¹, the E token embedding, the F token embedding, and the G token embedding.

Similarly, the second context embedding C2 may be linearly transformed by a predetermined linear layer to generate a plurality of second context injection embeddings P₁², P₂², . . . Pₖ². The third context embeddings C3 may be linearly transformed by a predetermined linear layer to generate a plurality of third context injection embeddings P₁³, P₂³, . . . Pₖ³, and the fourth context embedding C4 may be linearly transformed by a predetermined linear layer to generate a plurality of fourth context injection embeddings P₁⁴, P₂⁴, . . . Pₖ⁴.

In this way, each of the plurality of context embeddings C1, C2, C3, and C4 may be projected to at least one predetermined prefix token embedding, and the at least one prefix token embedding corresponding to each of the context embeddings may be used as an input value for the local attention operation.

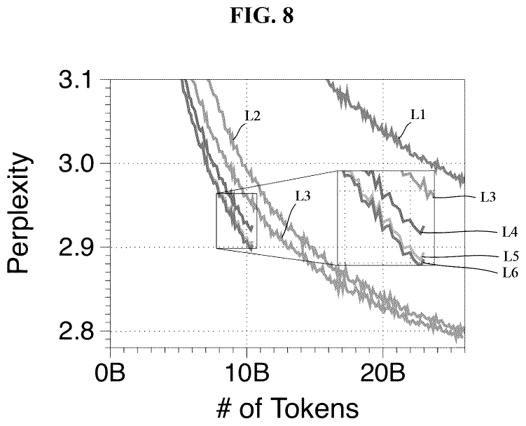

FIG. 8 is a schematic graph illustrating training perplexity of a language model based on a manner in which a plurality of context embeddings C1, C2, C3, and C4 is applied to an attention operation in the block transformer architecture 180 according to an embodiment.

Referring to FIG. 8, how three schemes of cross-attention, summation, and providing a prefix token embedding generated by linearly converting the plurality of context embeddings C1, C2, C3, and C4 as the input to the token decoder affect language model performance is shown.

For example, the cross-attention scheme based on a first curve L1 may exhibit the highest perplexity over the entire training period and exhibits relatively poor performance. This may suggest that in the cross-attention scheme, the reference to the context embedding as an external key/value is made at each decoding step, such that the computational resource consumption is large, while this scheme is rather inefficient in terms of training stability and expressiveness.

In addition, the summation scheme based on a second curve L2 also may exhibit a slightly higher perplexity than that in the prefix token embedding providing schemes based on third to sixth curves L3, L4, L5, and L6.

In an example, based on the third to sixth curves L1, L2, L3, L4, L5, and L6, it may be identified how the number of prefix token embeddings affects the language model performance.

For example, the third curve L3 may correspond to a case where the number of prefix token embeddings is 1, the fourth curve L4 may correspond to a case where the number of prefix token embeddings is 2, the fifth curve L5 may correspond to a case where the number of prefix token embeddings is 4, and the sixth curve L6 may correspond to a case where the number of prefix token embeddings is 6.

As the number of prefix token embeddings increases (1→2→4→6), the perplexity of the language model decreases stably. As the number of prefix token embeddings increases, the context information of the input sequence may be more abundantly reflected in the local attention operation process.

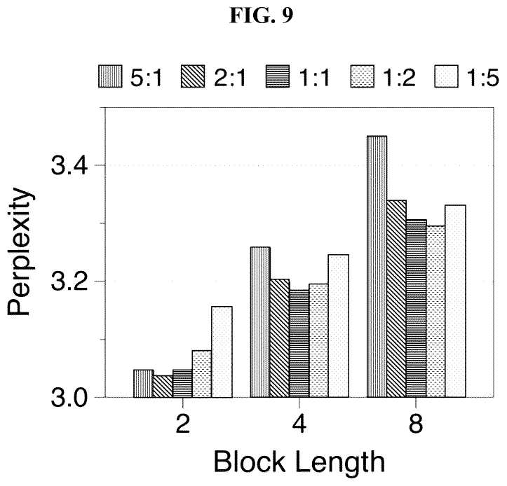

FIG. 9 is a schematic graph comparing a perplexity change of a language model based on a length of block embedding and a distribution ratio of training parameters to between a block decoder and a token decoder.

Referring to FIG. 9, a change in perplexity of the language model based on the parameter ratios 5:1, 2:1, 1:1, 1:2, and 1:5 of the block decoder and the token decoder and based on the different lengths 2, 4, and 8 of the block embedding is shown.

For example, the length of the block embedding may mean the number of input token embedding merged with each other to generate the block embedding. For example, a case in which the length of the block embedding is 4 may correspond to a case in which one block embedding is generated by merging four input token embeddings with each other.

For example, when the length of the block embedding is 4 while the training parameters are allocated to the block decoder and the token decoder at a 1:1 ratio, the lowest perplexity may be achieved, thereby indicating that the performance may be the best.

Accordingly, when the length of the block embedding is 4, the balance between the expressive ability of the block decoder summarizing the global context information and the local processing ability of the token decoder finely reconstructing the individual token based on the information may be most appropriately maintained.

In particular, in the block transformer architecture 180, when the length of the block embedding is set to 4, the language model may more stably exhibit high performance. If the length of the block embedding is too short, the global context expressiveness of the context embedding may be insufficient (more training parameter resources are required for the block decoder). Conversely, if the length thereof is too long, it may become difficult to achieve local reconstruction within the block (a greater number of training parameter resources are required for the token decoder). Thus, it may be difficult to set a balance point for distribution of training parameters. Therefore, setting the length of the block embedding to 4 may provide a structural advantage of effectively coordinating the trade-off between the computation resource of the language model and the information expression thereof.

The method S100 for training block transformer architecture model according to an embodiment may include preprocessing a input long sentences so as to be efficiently processed by processing input data in the form of a sequence to generate a plurality of input token embeddings, sequentially grouping and merging the plurality of input token embeddings into a plurality of block embeddings, in which each of the plurality of block embeddings includes a merge of a predetermined unit number (N) of token embeddings.

The block transformer architecture may perform a self-attention operation on the plurality of block embeddings to generate each of a plurality of context embeddings corresponding to each of the block embeddings. This context embedding may contain macroscopic contextual information about the entire sequence and plays an important role in the subsequent prediction process. Finally, the block transformer architecture may generate a subsequent predicted token embedding to each block in an autoregressive manner based on this context embedding to generate final predicted data.

The generated predicted data may be compared with the actual correct answer data and the comparing result is used to define a loss. This loss may be used as an indicator of how inaccurate the prediction of the model is. In order to reduce the loss, the block transformer architecture 180 may use a backpropagation algorithm to find out the cause of the loss and update all weights (parameters) of the model so as to minimize the loss. Through this process, the model gradually improves the accuracy of prediction and is trained by itself. Through repeated performance of the prediction and the backpropagation, the model may be optimized to deeply understand the context about the given sequence data and to make better inferences.

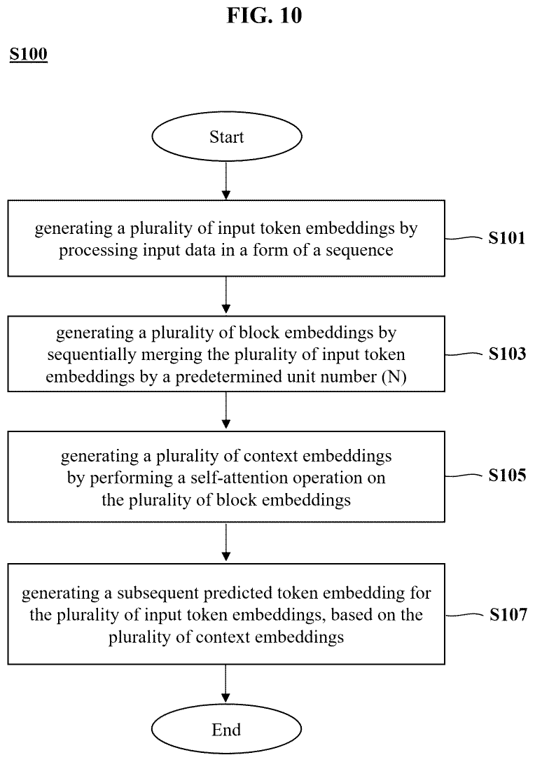

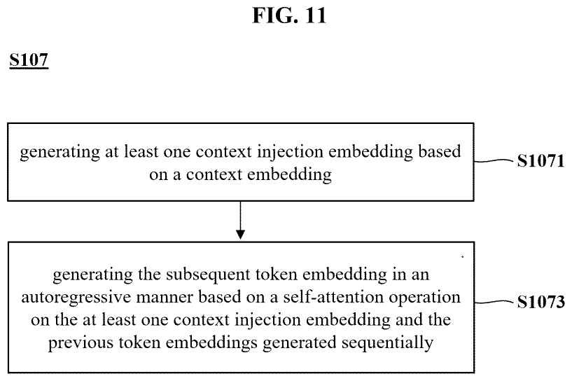

FIG. 10 is a schematic flowchart of a method S100 for training a block transformer architecture according to an embodiment. FIG. 11 is a schematic flowchart of a step S107 of generating a subsequent token embedding based on one context embedding as included in the method for training the block transformer architecture for FIG. 10.

Referring to FIG. 10, the method S100 for training the block transformer architecture according to an embodiment may include generating a plurality of input token embeddings A, B, C, D, E, F, G, H, I, J, K, L, M, N, O, and P by processing input data ID in a form of a sequence S101, generating a plurality of block embeddings B1, B2, B3, and B4 by sequentially merging the plurality of input token embeddings A, B, C, D, E, F, G, H, I, J, K, L, M, N, O, and P by a predetermined unit number N S103, generating a plurality of context embeddings C1, C2, C3, and C4 corresponding to each of the block embeddings B1, B2, B3, and B4 by performing a self-attention operation on the plurality of block embeddings B1, B2, B3, and B4 S105, and generating a subsequent predicted token embedding for the plurality of input token embeddings A, B, C, D, E, F, G, H, I, J, K, L, M, N, O, and P, based on the plurality of context embeddings C2, C1, C3, and C4 S107.

In an embodiment, the method S100 may be performed by the processor 131 included in the server computing system 130. However, the disclosure is not limited thereto, and at least a portion of the method S100 may be performed by the processor 111 of the user computing device 110, and another portion thereof may be performed by the processor 131 included in the server computing system 130.

Hereinafter, an example will be described in which the processor 131 of the server computing system 130 performs the method S100.

In step S101, the processor 131 of the server computing system 130 may generate the plurality of input token embeddings A, B, C, D, E, F, G, H, I, J, K, L, M, N, O, and P by processing input data in a form of a sequence.

For example, the input data ID in a predetermined sequence form may be subject to the tokenization and thus be converted into the input tokens by the processor 131.

The plurality of input tokens generated as a result of the tokenization of the input data ID may be converted into the plurality of input token embeddings A, B, C, D, E, F, G, H, I, J, K, L, M, N, O, and P by the processor 131.

For example, each of the tokens may be mapped to a vector space of a predetermined dimension, and the corresponding embedding thereto may be generated by a pre-trained embedding table or an embedding layer based on convolution or linear projection.

In step S103, the processor 131 of the server computing system 130 may generate the plurality of block embeddings B1, B2, B3, and B4 by sequentially merging the plurality of input token embeddings by a predetermined unit number (N).

In generating the plurality of block embeddings B1, B2, B3, and B4, the processor 131 of the server computing system 130 may sequentially group and merge the plurality of input token embeddings A, B, C, D, E, F, G, H, I, J, K, L, M, N, O, and P into the plurality of block embeddings B1, B2, B3, and B4, each blocking embedding including the merge of the predetermined unit number N of token embeddings. This grouping and merging process may be a preprocessing step for dividing the entire sequence into the blocks, each having a certain size, thereby increasing the efficiency of the subsequent attention operation.

For example, the predetermined unit number N of consecutive token embeddings may be integrated with each other via a simple concatenation or mean pooling to generate one block embedding. The block embedding generated in this way may be used as an input for a block-by-block global attention operation.

In step S105, the processor 131 of the server computing system 130 may generate the plurality of context embeddings C1, C2, C3, and C4 by performing a self-attention operation on the plurality of lock embeddings.

The processor 131 of the server computing system 130 may perform the global attention operation on the plurality of block embeddings B1, B2, B3, and B4 to generate a plurality of context embeddings C1, C2, C3, and C4 including global context information including the correlation between the plurality of block embeddings B1, B2, B3, and B4.

For example, the processor 131 of the server computing system 130 may learn what semantic association each block has relative to a block previous thereto by performing a masked self-attention operation between the plurality of block embeddings B1, B2, B3, and B4, and may output the context embedding corresponding to each block from the operation result.

In step S107, the processor 131 of the server computing system 130 may generate the predicted token embedding subsequent to the plurality of input token embeddings A, B, C, D, E, F, G, H, I, J, K, L, M, N, O, and P, based on the plurality of context embeddings C1, C2, C3, and C4.

More particularly, the processor 131 of the server computing system 130 may perform the local attention operation on the plurality of input token embedding groups G1, G2, G3, and G4 corresponding to the plurality of block embeddings B1, B2, B3, and B4 based on the plurality of context embeddings C1, C2, C3, and C4, and thus may sequentially output the predicted token embeddings.

For example, the processor 131 of the server computing system 130 may receive information about one of the plurality of context embeddings C1, C2, C3, and C4 as an input thereto, apply the information to an input token group corresponding to a subsequent block embedding to the block embedding corresponding to the received context embedding, and then perform the local attention operation in the corresponding token group to generate the predicted token embedding in an autoregressive manner.

In an example, in step S107, the processor 131 of the server computing system 130 may sequentially generate the plurality of input token embeddings corresponding to the block embedding subsequent to the block embedding corresponding to each of the plurality of context embeddings C1, C2, C3, and C4.

For example, the processor 131 of the server computing system 130 may sequentially generate a plurality of input token embeddings E, F, G, and H corresponding to the second block embedding B2 as the block embedding subsequent to the first block embeddings B1 corresponding to the first context embeddings C1, based on the information on the first context embeddings C1.

Thereafter, the processor 131 of the server computing system 130 may sequentially generate a plurality of input token embeddings I, J, K, and L corresponding to the third block embeddings B3 as the block embedding subsequent to the second block embeddings B2 corresponding to the second context embeddings C2, based on the information on the second context embeddings C2.

Similarly, the processor 131 of the server computing system 130 may sequentially generate a plurality of input token embeddings M, N, O, and P corresponding to the fourth block embeddings B4 based on the information on the third context embeddings C3. Moreover, the processor 131 of the server computing system 130 may sequentially generate a plurality of input token embeddings Q, R, S, and T corresponding to a subsequent block embedding to be generated in a subsequent manner to the fourth block embedding B4, based on the information on the fourth context embeddings C4.

For example, the processor 131 of the server computing system 130 may linearly transform the plurality of context embeddings C1, C2, C3, and C4 to generate the plurality of context injection embeddings P¹, P², P³, and P⁴. The plurality of context injection embeddings P¹, P², P³, and P⁴ may be provided as inputs to the local attention operation in the corresponding token group.

For example, referring to FIG. 11, step S107 may include step S1071 of generating at least one context injection embedding based on one context embedding and step S1073 of generating a subsequent token embedding in an autoregressive manner based on a self-attention operation on the at least one context injection embedding and the previous token embedding generated sequentially.

For example, in step S1071, the first context embedding C1 among the plurality of context embeddings C1, C2, C3, and C4 may be linearly transformed to generate a plurality of first context injection embeddings P₁¹, P₂¹, . . . Pₖ¹.

In addition, in step S1073, the E token embedding may be generated based on the plurality of first context injection embeddings P₁¹, P₂¹, . . . Pₖ¹, the F token embedding may be generated based on the first context injection embeddings P₁¹, P₂¹, . . . Pₖ¹ and the E token embedding, the G token embedding may be generated based on the first context injection embeddings P₁¹, P₂¹, . . . Pₖ¹, the E token embedding, and the F token embedding. The H token embedding may be generated based on the first context injection embeddings P₁¹, P₂¹, . . . Pₖ¹, the E token embedding, the F token embedding, and the G token embedding.

Similarly, the second context embedding C2 may be linearly transformed to generate a plurality of second context injection embeddings P₁², P₂², . . . Pₖ². The I token embedding, J token embedding, K token embedding, and L token embedding may be sequentially generated in an autoregressive manner based on the plurality of second context injection embeddings P₁², P₂², . . . Pₖ².

In addition, the third context embedding C3 may be linearly transformed to generate a plurality of third context injection embeddings P₁³, P₂³, . . . Pₖ³. The M token embedding, N token embedding, O token embedding, and P token embedding may be sequentially generated in an autoregressive manner based on the plurality of third context injection embeddings P₁³, P₂³, . . . Pₖ³.

Furthermore, the fourth context embedding C4 may be linearly transformed to generate a plurality of fourth context injection embeddings P₁⁴, P₂⁴, . . . Pₖ⁴. The Q token embedding, R token embedding, S token embedding, and T token embedding may be sequentially generated in an autoregressive manner based on the plurality of fourth context injection embeddings P₁⁴, P₂⁴, . . . Pₖ⁴.

In addition, the method S100 may further include merging a plurality of input token embeddings generated based on the last context embedding among the plurality of context embeddings C1, C2, C3, and C4 to generate an additional block embedding subsequent to the last context embedding, and generating each of the plurality of context embeddings corresponding to each of the block embeddings by performing a self-attention operation again on the plurality of block embeddings and the additional subsequent block embedding.

For example, referring to FIG. 6, the processor 131 of the server computing system 130 may generate a plurality of input token embeddings Q, R, S, and T based on the fourth context embeddings C4 as the last one among the plurality of context embeddings C1, C2, C3, and C4, and may merge the generated plurality of input token embeddings Q, R, S, and T to generate the additional subsequent block embedding (not shown).

In addition, the processor 131 of the server computing system 130 may perform the self-attention operation again on the plurality of previously generated block embeddings B1, B2, B3, and B4 and the additional subsequent block embedding to generate a plurality of new context embeddings reflecting the extended input sequence.

In this way, in step S107, the plurality of input token embeddings E, F, G, H, I, J, K, L, M, N, O, P, Q, R, S, and T generated based on the plurality of context embeddings C1, C2, C3, and C4 by the processor 131 of the server computing system 130 may be referred to as a plurality of output token embeddings in terms of input/output. The predicted data PD in response to the input data ID may be generated based on the plurality of output token embeddings.

For example, when the input data ID is a text, each of the plurality of output token embeddings may be linearly converted to the same dimension as a vocabulary dictionary size inside the language model, and accordingly, a plurality of log it embeddings may be generated. A softmax function may be applied to the plurality of log it embeddings to generate a probability distribution for each of words included in the vocabulary dictionary, and the predicted data PD in the form of a text may be generated based on the probability distribution.

The embodiments according to the present disclosure described above may be implemented in the form of program instructions that may be executed through various computer components and recorded in a computer-readable recording medium. The computer-readable recording medium may include program instructions, data files, data structures, and the like alone or in combination with each other. The program instructions recorded in the computer-readable recording medium may be specially designed and configured for the present disclosure or may be known and available to those skilled in the field of computer software. Examples of computer-readable recording media include hardware devices specially configured to store therein and execute program instructions, such as magnetic media such as hard disks, floppy disks and magnetic tapes, optical recording media such as CD-ROM and DVD, magneto-optical media such as floptical disks, and ROM, RAM, flash memory, and the like. Examples of the program instructions include not only machine language codes such as those generated by the compiler, but also high-level language codes that may be executed by a computer using an interpreter or the like. The hardware device may be changed to one or more software modules to perform processing according to the present disclosure, and vice versa.

The specific executions described in the present disclosure are examples, and the scope of the present disclosure is not limited thereto in any manner. For the sake of brevity of the present disclosure, the description of conventional electronic configurations, control systems, software, and other functional aspects of the systems may be omitted. In addition, the connection or connection members of the lines between the components illustrated in the drawings exemplarily represent functional connections and/or physical or circuit connections, and may be represented as various alternative or additional functional connections, physical connections, or circuit connections in an actual device. In addition, if there is no specific mention such as “essential”, “important”, or the like, it may not be an essential component for the application of the present disclosure.

According to various embodiments of the disclosure, a purpose of the present disclosure is to provide a method and system for training a block transformer architecture model, the method and system converting a sequence input into a plurality of input token embeddings, grouping and merging a plurality of input token embeddings into a plurality of block embeddings, wherein each of the plurality of block embeddings includes a merge of a predetermined number of input token embeddings, and performing a global attention operation on the plurality of block embeddings, and applying the global attention operation result to a plurality of input token embedding groups corresponding to the plurality of block embeddings, and then performing a local attention operation in each of the groups, thereby greatly reducing computational complexity and memory I/O.

According to various embodiments of the present disclosure, a purpose of the present disclosure is to provide a method and system for training a block transformer architecture model, the method and system converting a sequence input into a plurality of input token embeddings, grouping and merging a plurality of input token embeddings into a plurality of block embeddings, wherein each of the plurality of block embeddings includes a merge of a predetermined number of input token embeddings, and performing a global attention operation on the plurality of block embeddings to generate a plurality of context embeddings, and applying each of the context embeddings to an input token embedding group via linear transformation, thereby more precisely applying global context information to a local attention operation performed in each of the groups to output a predicted output.

The method and system for training the block transformer architecture model according to various embodiments of the present disclosure may enable macroscopic context information extraction on a block basis of the sequence input by grouping and merging the token embeddings of the sequence input into the plurality of block embeddings, each including the merge of the predetermined unit number of token embeddings, and performing a global attention operation on the plurality of block embeddings.

In addition, the method and system for training the block transformer architecture model according to various embodiments of the present disclosure may apply the global attention operation result to the plurality of input token embedding groups corresponding to the plurality of block embeddings, and then performing a local attention operation in each of the groups to output the predicted token embedding, thereby significantly reducing computation complexity and memory I/O. Thus, high inference performance may be maintained even in a process of processing a long sequence input even at a significantly lower amount of computation and a significantly lower memory requirement, compared to a conventional transformer architecture.

Furthermore, the method and system for training the block transformer architecture model according to various embodiments of the present disclosure may group and merge the plurality of input token embedding into the plurality of block embeddings, each including the merge of the predetermined unit number of input token embeddings and perform a global attention operation on the plurality of block embeddings, and apply the plurality of context embeddings generated by performing the global attention operation to the plurality of input token embedding groups via linear transformation, thereby precisely applying global context information to the local attention operation performed in each of the groups, and accordingly, appropriately interpreting the meaning of the entire sequence input and thus more accurately outputting the predicted token.

Although the detailed description of the present disclosure has been made with reference to the preferred embodiments of the present disclosure, it will be understood that those skilled in the art or those skilled in the art can variously modify and change the present disclosure within the scope not departing from the spirit and technical areas of the present disclosure described in the claims to be described later. Therefore, the technical scope of the present disclosure is not limited to the contents described in the detailed description of the specification but should be determined by the claims.

What is claimed is:

1. A computer-implemented method for training a block transformer architecture model, the method comprising:
generating a plurality of input token embeddings by processing input data in a form of a sequence;
generating a plurality of block embeddings by sequentially merging the plurality of input token embeddings into a predetermined unit number;
generating a plurality of context embeddings by performing a self-attention operation on the plurality of block embeddings, wherein each of the plurality of context embeddings corresponds to each of the block embeddings; and
generating a subsequent predicted token embedding for the plurality of input token embeddings, based on the plurality of context embeddings.

2. The method of claim 1, wherein the generating of the subsequent predicted token embedding includes:
generating subsequent token embedding by sequentially generating a plurality of input token embeddings corresponding to a subsequent block embedding of a block embedding for a context embedding using information about the context embedding among the plurality of context embeddings as input, wherein the subsequent token embedding is generated by referring to previously generated token embeddings.

3. The method of claim 2, the method further comprises:
generating an additional subsequent block embedding corresponding to the sequence following a last sequence by merging the plurality of input token embeddings generated based on a context embedding corresponding to the last sequence among the plurality of context embeddings; and
generating a plurality of context embeddings by performing a self-attention operation again on the plurality of block embeddings and the additional subsequent block embedding, each of the plurality of context embeddings corresponding to each of the block embeddings.

4. The method of claim 2, wherein the generating of the subsequent token embedding includes sequentially generating a plurality of input token embeddings corresponding to a subsequent block embedding of a block embedding for the context embedding for all of the plurality of context embeddings.

5. The method of claim 1, wherein each of the plurality of block embeddings is generated by performing a concatenation of the predetermined unit number of input token embeddings arranged in order.

6. The method of claim 1, wherein the predetermined unit number is four.

7. The method of claim 2, wherein the generating of the subsequent token embedding includes:
generating at least one context injection embedding based on the context embedding; and
generating the subsequent token embedding in an autoregressive manner based on a self-attention operation on the at least one context injection embedding and the previous token embeddings generated sequentially.

8. The method of claim 7, wherein the generating of the at least one context injection embedding includes generating the at least one context injection embedding via linear transformation of the context embedding.

9. The method of claim 8, wherein the generating of the at least one context injection embedding includes generating a plurality of context injection embeddings via linear transformation of the context embedding.

10. The method of claim 7, wherein training parameters are evenly allocated to a block decoder and a token decoder,
wherein the block decoder is configured to perform a self-attention operation on the plurality of block embeddings, and
wherein the token decoder is configured to perform a self-attention operation on the at least one context injection embedding and the previous token embeddings generated sequentially”.

11. The method of claim 1, wherein the generating of the plurality of input token embeddings includes:
generating a plurality of input tokens by processing the input data in a form of the sequence; and
generating the plurality of input token embeddings based on the plurality of input tokens.

12. A system for training a block transformer architecture model, the system comprising:
at least one memory; and
at least one processor configured to read-out at least one instruction stored in the at least one memory and configured to perform a method for training a block transformer architecture model based on the at least one instruction,
wherein the at least one processor is configured to:
generate a plurality of input token embeddings by processing input data in a form of a sequence,
generate a plurality of block embeddings by sequentially merging the plurality of input token embeddings into a predetermined unit number,
generate a plurality of context embeddings by performing a self-attention operation on the plurality of block embeddings, wherein each of the plurality of context embeddings corresponds to each of the block embeddings, and
generate a subsequent predicted token embedding for the plurality of input token embeddings, based on the plurality of context embeddings.

13. The system of claim 12, wherein, in the generating of the subsequent predicted token embedding, the at least one processor is configured to:
generate subsequent token embedding by sequentially generating a plurality of input token embeddings corresponding to a subsequent block embedding of a block embedding for a context embedding using information about the context embedding among the plurality of context embeddings as input, wherein the subsequent token embedding is generated by referring to previously generated token embeddings.

14. The system of claim 12, the system further comprises:
a plurality of neurons, each neuron including an array, wherein the array includes at least one register, at least one programmable logic, and at least one input interface;
a plurality of synaptic circuits configured to store synaptic weights for adjusting connection strengths between the plurality of neurons; and
at least one routing network configured to control data flow between the plurality of neurons,
wherein each of the plurality of neurons further includes a field programmable gate array (FPGA) for a predetermined artificial neural network connected to at least another neuron via the routing network and configured to set a transfer path of the weight.

15. The system of claim 12, the system further comprises:
a plurality of neurons, each neuron including an array, wherein the array includes at least one register, at least one microprocessor, and at least one input; and
a plurality of synaptic circuits configured to store synaptic weights for adjusting connection strengths between the plurality of neurons,
wherein each of the plurality of neurons further includes an application-specific integrated circuit (ASIC) for a predetermined artificial neural network connected to at least another neuron via one of the plurality of synaptic circuits.

16. The system of claim 12, wherein, in the generating of the subsequent predicted token embedding, the at least one processor is configured to:
sequentially generating a plurality of input token embeddings corresponding to a subsequent block embedding of a block embedding for the context embedding for all of the plurality of context embeddings.

17. The system of claim 12, wherein each of the plurality of block embeddings is generated by performing a concatenation of the predetermined unit number of input token embeddings arranged in order.

18. The system of claim 12, wherein the predetermined unit number is four.

19. The system of claim 13, wherein, in the generating of the subsequent token embedding includes:
generating at least one context injection embedding based on the context embedding; and
generating the subsequent token embedding in an autoregressive manner based on a self-attention operation on the at least one context injection embedding and the previous token embeddings generated sequentially.

20. The method of claim 19, wherein, in the generating of the at least one context injection embedding includes generating the at least one context injection embedding via linear transformation of the context embedding.
